(19) United States
(12) Patent Application Publication
(10) Pub. No.: US 2016/0286634 A1
(43) Pub. Date: Sep. 29, 2016

(54) AIRFIELD LIGHTS CONTROL AND MONITORING SYSTEM

(71) Applicant: LSIS CO., LTD., Anyang-si (KR)

(72) Inventors: Dongsun WON, Anyang-si (KR); Jaeshik YOON, Anyang-si (KR)

(73) Assignee: LSIS CO., LTD., Anyang-si (KR)

(21) Appl. No.: 14/975,409

(22) Filed: Dec. 18, 2015

(30) Foreign Application Priority Data
Mar. 23, 2015 (KR) 10-2015-0039833

(51) Int. Cl. H05B 37/03; B64F 1/20; H05B 37/02

(52) U.S. Cl. CPC H05B 37/03; H05B 37/0209; B64F 1/20

(57) ABSTRACT

Disclosed is an airfield lights control and monitoring system for supplying a constant current to a plurality of lighting devices. The airfield lights control and monitoring system includes a server configured to transmit a lighting device control command for controlling the plurality of lighting devices, a constant current regulator configured to supply a predetermined current to the plurality of lighting devices according to external control, and first and second central devices configured to receive the lighting device control command to control the constant current regulator according to the received lighting device control command. The first and second central devices transfer the lighting device control command there between.

### CROSS-REFERENCE TO RELATED APPLICATION

Pursuant to 35 U.S.C. §119(a), this application claims the benefit of earlier filing date and right of priority to Korean Patent Application No. 10-2015-0039833, filed on Mar. 23, 2015, the contents of which are hereby incorporated by reference herein in its entirety.

### BACKGROUND OF THE DISCLOSURE

1. Field of the Disclosure

The present disclosure relates to an airfield lights control and monitoring system, and particularly, to an airfield lights control and monitoring system for stably controlling a constant current regulator.

2. Background of the Disclosure

An individual lamp control and monitoring system for airfield lights is a system that is installed on a runway and a taxiway to control turn-on/off of airfield lights and monitor an airfield lights state.

An airfield lights power source is configured as a constant current source including a single loop, and a length of a cable from a constant current regulator generating a constant source current to a final end lamp on a runway is several km to tens km, and tens to hundreds of lamps are located between the constant current regulator and the final end lamp.

The airfield lights power source configured as a single loop supplies power to secondary lamps and an electronic circuit, used to operate an airfield lights control and monitoring system, through an embedded transformer having a characteristic of a current transformer.

An efficient airfield lights control and monitoring system may be implemented by applying power line communication technology without installing an additional control line.

FIG. 1 is a diagram illustrating a configuration of a related art airfield lights control and monitoring system 100. Referring to FIG. 1, the airfield lights control and monitoring system 100 includes a server 110, a constant current regulator 120, dualized central devices 130 and 150, and a plurality of lighting devices 140.

The server 110 is connected to the central devices 130 and 135 to control the central devices 130 and 135. Also, the server 110 individually controls the lighting devices 140 by using communication of the central devices 130 and 135 and receives and monitors states of the lighting devices 140.

In particular, the server 110 controls the constant current regulator 120 through the central devices 130 and 135 to adjust a constant current supplied to the lighting devices 140, thereby adjusting the brightness of lights irradiated from the lighting devices 140.

Therefore, in the airfield lights control and monitoring system, the monitoring function of the central devices 130 and 135 is most important. For this reason, the central devices 130 and 135 are dualized, and thus are configured with a master in an active state and a slave in a standby state or configured with a master and a master, thereby controlling the constant current regulator 120.

The constant current regulator 120 supplies predetermined currents having various values to the lighting devices 140 through a power line. The central devices 130 and 135 control a step of the constant current regulator 120, thereby allowing the constant current regulator 120 to supply a current according to the control.

In this case, each of two the central devices 130 and 135 is connected to the constant current regulator 120 through a control line and controls a step of the constant current regulator through contact control to adjust a current supplied to the constant current regulator 120.

As described above, in a case where the two central devices 130 and 135 control a step of one the constant current regulator 120, only when all the two central devices 130 and 135 operate as masters, it is possible to control the constant current regulator 120. For this reason, in a case where it is unable for one of the central devices 130 and 135 to control the constant current regulator 120, even when the other central device normally operates, it is unable to normally control the constant current regulator 120.

Therefore, the server 110 transmits a command for step adjustment to each of the two central devices 130 and 135, for adjusting the brightness of airfield lights.

For example, when communication is normally performed between the server 110 and the two central devices 130 and 135, the constant current regulator 120 is normally controlled. However, when the two central devices 130 and 135 receive different commands from the server 110 or one of the two central devices 130 and 135 cannot normally communicate with the server 110, the constant current regulator 120 cannot normally be controlled.

For example, it is assumed that while the constant current regulator 120 is supplying a fourth-step current according to a previous command, a communication defect occurs between one central device and the server 110.

In this case, when the server 110 transmits, to each of the two central devices 130 and 135, a command for controlling a step of the constant current regulator 120 to a second-step, the one central device which normally operates intends to control the constant current regulator 120 so as to supply a second-step current, but the other central device having the defect continuously controls the constant current regulator 120 so as to supply the fourth-step current. For this reason, one the constant current regulator 120 is differently controlled by the two central devices 130 and 135.

However, since a step of the constant current regulator 120 should be always controlled to the same step by the central devices 130 and 135, a problem where a command from the central device 130 mismatches a command from the central device 135 can occur. For this reason, a step of the constant current regulator 120 is always controlled to an upper step (a fourth-step in the above assumption).

### SUMMARY OF THE DISCLOSURE

Therefore, the present invention is devised to solve the problem as stated above. The purpose of the present invention is to provide an airfield lights control and monitoring system for stably controlling a constant current regulator.

To achieve the above purpose, an airfield lights control and monitoring system according to an embodiment of the present invention includes: a server configured to transmit a lighting device control command for controlling the plurality of lighting devices; a constant current regulator configured to supply a predetermined current to the plurality of lighting devices according to external control; and first and second central devices configured to receive the lighting device control command to control the constant current regulator according to the received lighting device control command, wherein the first and second central devices transfer the lighting device control command therebetween.

When one of the first and second central devices cannot normally communicate with the server, one central device that normally communicates with the server may control the constant current regulator according to the lighting device control command and may transfer the lighting device control command to the other central device that cannot normally communicate with the server.

The one central device may control the constant current regulator and may transmit an operating state thereof to the server.

The other central device may receive the lighting device control command from the one central device and may control the constant current regulator according to the received lighting device control command.

The other central device may control the constant current regulator and transmits an operating state thereof to the one central device, and the one central device may transfer the received operating state of the other central device to the server.

The server may check a connection state between the first central device and the second central device and may transmit the lighting device control command to a central device, which is determined as normally performing communication, among the first and second central devices.

The one central device may transfer the lighting device control command to the other central device, and when the one central device does not receive an operating state from the other central device, the one central device may transmit a defective condition of the other central device to the server.

The server may transmit the lighting device control command to the first and second central devices and may determine whether the first and second central devices normally operate, based on whether a reception check response is received from the first and second central devices.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a diagram illustrating a configuration of a related art airfield lights control and monitoring system;

FIG. 2 is a diagram illustrating a configuration of an airfield lights control and monitoring system according to an embodiment of the present invention;

FIG. 3 is a flowchart illustrating a sequence based on a first operation of an airfield lights control and monitoring system according to an embodiment of the present invention; and

FIG. 4 is a flowchart illustrating a sequence based on a second operation of an airfield lights control and monitoring system according to an embodiment of the present invention.

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Like reference numerals refer to like elements throughout.

Detailed descriptions related to well-known functions or configurations will be ruled out in order not to unnecessarily obscure subject matters of the present invention. Moreover, the terms used henceforth have been defined in consideration of the functions of the present invention, and may be altered according to the intent of a user or operator, or conventional practice. Therefore, the terms should be defined on the basis of the entire content of this specification.

Hereinafter, a configuration and an operation of an airfield lights control and monitoring system according to an embodiment of the present invention will be described in detail with reference to the accompanying drawings.

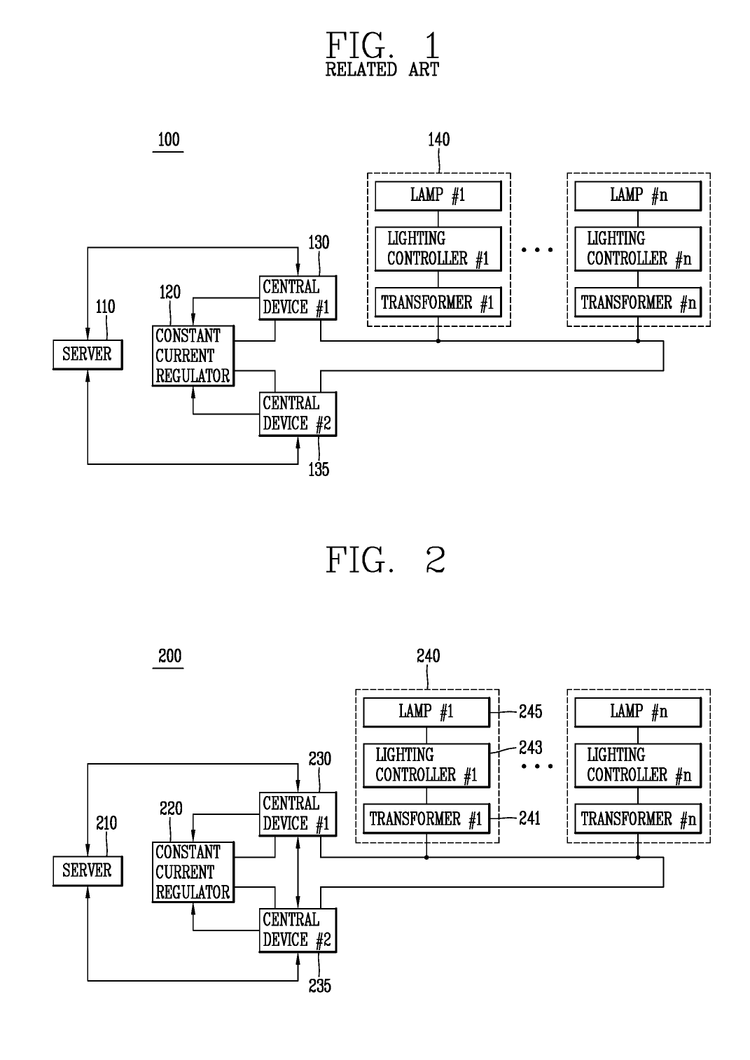

FIG. 2 is a diagram illustrating a configuration of an airfield lights control and monitoring system 100 according to an embodiment of the present invention.

Referring to FIG. 2, the airfield lights control and monitoring system 200 according to the embodiment of the present invention may include a server 210, a constant current regulator 220, two central devices 230 and 235, and a plurality of lighting devices 240.

Here, the two central devices 230 and 230 may be configured to transmit or receive a signal to or from the plurality of lighting devices 240 through, for example, power line communication, Ethernet communication, universal asynchronous receiver/transmitter (UART, a general-use asynchronous transceiver) communication, or the like. Hereinafter, a case of using power line communication will be described as an example.

In the present embodiment, the airfield lights control and monitoring system 200 is described as including the two central devices 230 and 235 for example. In other embodiments, the airfield lights control and monitoring system 200 may be configured as including more central devices, and even in this case, a method to be described below is identically applied thereto. Hereinafter, also, the two central devices 230 and 235 will be described as being classified into a first central device 230 and a second central device 235. It can be understood by those skilled in the art that the two central devices 230 and 235 have the same configuration.

The server 210 may be connected to the two central devices 230 and 235 through, for example, Ethernet communication and may control states of the two central devices 230 and 235 and transmit, to each of the two central devices 230 and 235, a control command (a lighting device control command) for individually controlling the plurality of lighting devices 240. Also, the server 210 may be supplied with states of the lighting devices 240 through the two central devices 230 and 235 and may monitor the states of the lighting devices 240.

In this case, the server 210 may control or monitor the lighting devices 240 through the central devices 230 and 235 which is previously set to communicate with the lighting devices 240. One of the two central devices 230 and 235 may be set to communicate with the lighting devices 240, and both of the two central devices 230 and 235 may be set to communicate with the lighting devices 240.

Moreover, the server 210 may be provided as one and may be connected to each of the two central devices 230 and 235, or the server 210 may be provided as two and may be respectively connected to the two central devices 230 and 235. In this case, if the server 210 is provided as two, the two servers 210 may respectively transmit the same lighting device control command to the central devices 230 and 235, connected thereto.

Moreover, the server 210 may control the central devices 230 and 235 to control the constant current regulator 220 that supplies a constant current to the lighting devices 240, thereby adjusting the brightness of lights irradiated from the lighting devices 240. Also, the server 210 may receive an operating state transmitted from the central devices 230 and 235 to monitor states of the central devices 230 and 235.

In this case, the server 210 may transmit the lighting device control command to one of the two central devices 230 and 235. That is, the server 210 may transmit the lighting device control command to the first central device 230 or the second central device 235 according to a setting.

Moreover, the server 210 may transmit the lighting device control command to both of the two central devices 230 and 235.

At this time, the server 210 may check connection states with the two central devices 230 and 235, and based on a result of the check, the server 210 may transmit the lighting device control command to both of the two central devices 230 and 235 or may transmit the lighting device control command to one of the two central devices 230 and 235. Furthermore, the server 210 may display the connection states with the two central devices 230 and 235 so as to be seen from the outside.

In this case, the server 210 may check the connection states with the two central devices 230 and 235, and when it is determined that the server 210 is able to normally communicate with the two central devices 230 and 235, the server 210 may transmit the lighting device control command to the two central devices 230 and 235.

On the other hand, the server 210 may check the connection states with the two central devices 230 and 235, and when it is determined that the server 210 is able to normally communicate with one of the two central devices 230 and 235, the server 210 may transmit the lighting device control command to the one central device capable of normally communicating with the server 210.

Moreover, the server 210 may check the connection states with the two central devices 230 and 235, and when it is determined that the server 210 cannot normally communicate with both of the two central devices 230 and 235, the server 210 may issue a warning corresponding to a current condition.

The server 210 may preferentially transmit the lighting device control command to the two central devices 230 and 235. The server 210 may transmit the lighting device control command to both of the two central devices 230 and 235 or one of the two central devices 230 and 235, based on whether a reception check response is received from the two central devices 230 and 235.

That is, the server 210 may transmit the lighting device control command to the two central devices 230 and 235. The server 210 may determine whether the two central devices 230 and 235 normally operate, based on whether the reception check response is received from the two central devices 230 and 235.

Therefore, the server 210 may transmit the lighting device control command to the two central devices 230 and 235, and when the reception check response is received from both of the two central devices 230 and 235, the server 210 may continuously transmit the lighting device control command to both of the two central devices 230 and 235.

On the other hand, the server 210 may transmit the lighting device control command to the two central devices 230 and 235, and when the reception check response is received from one of the two central devices 230 and 235 and is not received from the other central device, the server 210 may transmit the lighting device control command to the one central device which has transmitted the reception check response.

Therefore, the server 210 may transmit the lighting device control command to both of the two central devices 230 and 235 or may transmit the lighting device control command to one of the two central devices 230 and 235, based on the connection states with the two central devices 230 and 235.

Furthermore, the server 210 may transmit, to the two central devices 230 and 235, the lighting device control command and a command mutual transfer message for allowing each of the two central devices 230 and 235 to transmit a command received thereby to the other central device.

That is, the server 210 may transmit the lighting device control command and the command mutual transfer message to the two central devices 230 and 235, thereby allowing the first central device 230 to transmit the lighting device control command received thereby to the second central device 235 and allowing the second central device 235 to transmit the lighting device control command received thereby to the first central device 230.

The constant current regulator 220 may operate according to control by the central devices 230 and 235 to supply a predetermined current to the plurality of lighting devices 240 through a power line, thereby adjusting the brightness of lights irradiated from the lighting devices 240.

In this case, the constant current regulator 220 may operate according to control by the central devices 230 and 235 to supply the current to the plurality of lighting devices 240 through the power line.

The constant current regulator 220 may supply currents having different values to the power line according to control by the central devices 230 and 235. Also, the constant current regulator 220 may be configured with elements selected from among various elements known to those skilled in the art, and thus, its detailed structure has been omitted.

Each of the central devices 230 and 235 may be connected to the server 210 and the constant current regulator 220, may receive the lighting device control command transmitted from the server 210, and may operate according to the received lighting device control command to control the constant current regulator 220.

Moreover, the central devices 230 and 235 may be connected to each other through, for example, UART communication.

In this case, the central devices 230 and 235 may transmit their operating states to the server 210 in order for the server 210 to check the operating states. In this case, each of the operating states denotes an operation which has been performed according to the lighting device control command.

At this time, each of the central devices 230 and 235 may receive the lighting device control command transmitted from the server 210 or may receive the lighting device control command transmitted from the other central device to control the constant current regulator 220.

That is, when the central devices 230 and 235 are normally connected to the server 210, the central devices 230 and 235 may receive the lighting device control command transmitted from the server 210 to control the constant current regulator 220.

On the other hand, one of the central devices 230 and 235 that is not normally connected to the server 210 may receive the lighting device control command transmitted from the other central device to control the constant current regulator 220.

For example, when both of the two central devices 230 and 235 are normally communicating with the server 210, the two central devices 230 and 235 may receive the lighting device control command transmitted from the server 210, control the constant current regulator 220 according to the lighting device control command, and transmit their operating states to the server 210.

On the other hand, when the first central device 230 is normally communicating with the server 210 and the second central device 235 cannot normally communicate with the server 210, the first central device 230 may receive the lighting device control command transmitted from the server 210, control the constant current regulator 220 according to the lighting device control command, and transmit its operating state to the server 210.

Subsequently, the first central device 230 may transfer the lighting device control command to the second central device 235, and the second central device 235 which has received the lighting device control command transmitted from the first central device 230 may control the constant current regulator 220 according to the lighting device control command and may transmit its operating state to the first central device 230. The first central device 230 may transfer the operating state, transmitted from the second central device 235, to the server 210.

Hereinabove, a case where the first central device 230 normally communicates with the server 210 and the second central device 235 cannot normally communicate with the server 210 has been described as an example. However, it can be understood by those skilled in the art that the above-described operation may be applied to a case where the second central device 235 normally communicates with the server 210 and the first central device 230 cannot smoothly communicate with the server 210.

Moreover, hereinabove, a case, where when at least one of the two central devices 230 and 235 cannot normally communicate with the server 210, one of the central devices 230 and 235 that normally communicates with the server 210 transfers the lighting device control command to the other central device that cannot normally communicate with the server 210, has been described as an example.

In this case, when the first and second central devices 230 and 235 receive the command mutual transfer message from the server 210 along with the lighting device control command, the first central device 230 may transfer the received lighting device control command to the second central device 235, and the second central device 235 may transfer the received lighting device control command to the second central device 230, irrespective of an operating state of the other central device.

That is, according to the embodiment of the present invention, when the two central devices 230 and 235 receive the lighting device control command from the server 210, the two central devices 230 and 235 may transmit and receive the lighting device control command therebetween. In particular, when two central devices 230 and 235 receive the command mutual transfer message from the server 210 along with the lighting device control command, the two central devices 230 and 235 may transmit and receive the command mutual transfer message therebetween.

The lighting devices 240 may receive a current supplied from the constant current regulator 220 and a control command transmitted from each of the two central devices 230 and 235 and may operate according to the received current and the control command. In this case, the control command transmitted from each of the two central devices 230 and 235 to the lighting devices 240 may differ from the lighting device control command.

That is, the lighting device control command may be a command for controlling the constant current regulator 220 so as to adjust the brightness of lights irradiated from the lighting devices 240, and the control command transmitted from each of the central devices 230 and 235 may be a command for allowing the central devices 230 and 235 to directly control the lighting devices 240.

In this case, the lighting devices 240 each may include a transformer 241, a lighting controller 243, and a lamp 245. This is an example of a configuration of each of the lighting devices 240, and the lighting devices 240 are not limited thereto. The lighting devices 240 may be configured in an arbitrary structure known to those skilled in the art.

The transformer 241 may receive power applied through the power line and may transfer the applied power to the lighting controller 243.

That is, the transformer 241 may transform the applied power into power having a level and a frequency which are suitable for the lighting controller 243, and may transfer the transformed power to the lighting controller 243.

The lighting controller 243 may control an operation of the lamp 245, based on the power applied through the transformer 241. In this case, the lighting controller 243 may be configured in a structure selected from among various structures known to those skilled in the art, and thus, its detailed description has been omitted.

Hereinabove, the configuration and the function of the airfield lights control and monitoring system according to the embodiment of the present invention have been described. Hereinafter, a detailed operation of the airfield lights control and monitoring system having the configuration as illustrated in FIG. 2 will be sequentially described with reference to the accompanying drawings.

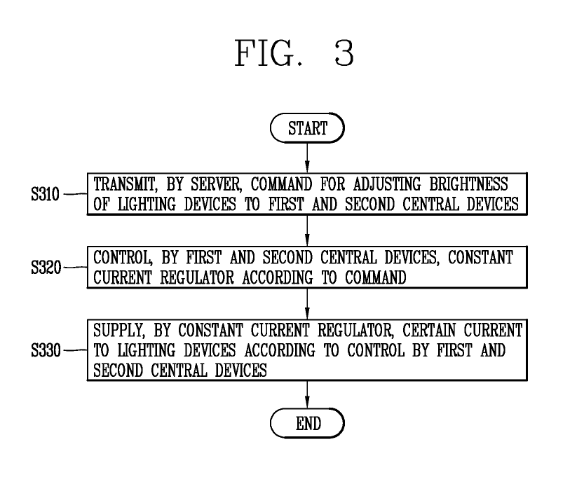

FIG. 3 is a flowchart illustrating a sequence based on a first operation of the airfield lights control and monitoring system according to an embodiment of the present invention.

FIG. 3 illustrates an operation sequence of the airfield lights control and monitoring system when all central devices configuring the airfield lights control and monitoring system normally operate. In operation S310, the server 210 may transmit, to the first and second central devices 230 and 235, a command for adjusting the brightness of lights irradiated from the lighting devices 240.

In this case, a command transmitted from the server 210 to the first central device 230 may be the same as a command transmitted from the server 210 to the second central device 240. Also, the server 210 may transmit a command mutual transfer request message to the first and second central devices 230 and 235 along with the command.

When the first and second central devices 230 and 235 receive the command which is transmitted from the server 210 in operation S310, the first and second central devices 230 and 235 may control the constant current regulator 220 according to the received command in operation S320.

At this time, the first and second central devices 230 and 235 may control the constant current regulator 220 in order for the constant current regulator 220 to output a specific current value among a plurality of predetermined current values.

Moreover, the first and second central devices 230 and 235 may control the constant current regulator 220 and then may transmit their operating states to the server 210.

Moreover, when the command mutual transfer request message is transmitted along with the command in operation S310, each of the first and second central devices 230 and 235 may transfer the received command to the other central device.

That is, the first central device 230 may transfer the received command to the second central device 235, and the second central device 235 may transfer the received command to the first central device 230.

Subsequently, in operation S330, the constant current regulator 220 may supply a certain current to the lighting devices 240 through the power line in response to control by the first and second central devices 230 and 235.

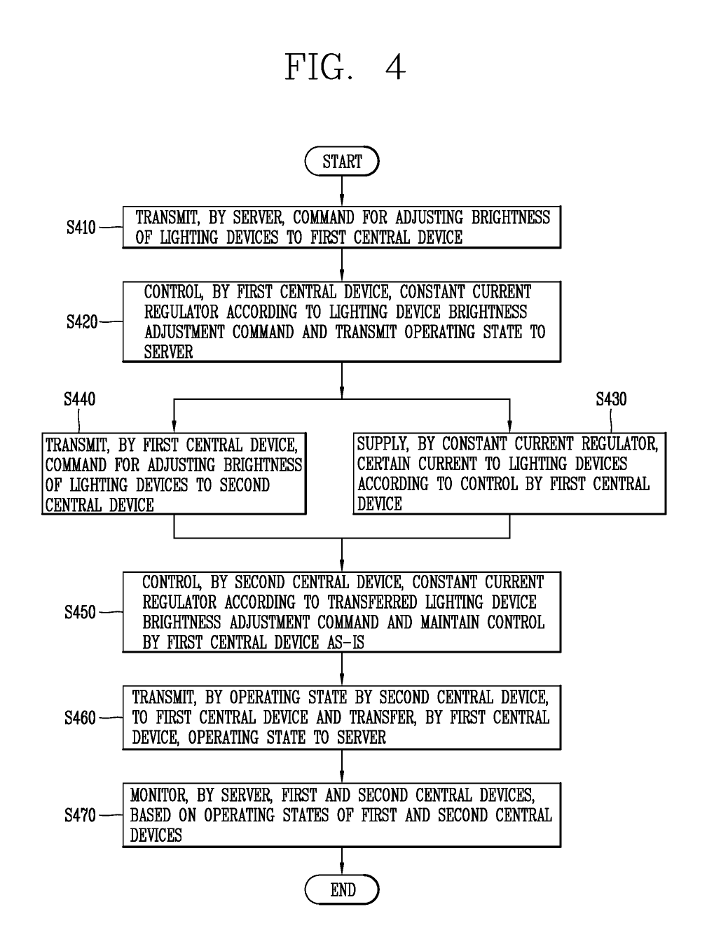

FIG. 4 is a flowchart illustrating a sequence based on a second operation of the airfield lights control and monitoring system according to an embodiment of the present invention.

FIG. 4 illustrates an operation sequence of the airfield lights control and monitoring system when at least one of the central devices configuring the airfield lights control and monitoring system cannot normally operate. The following description will be made on the assumption that the first central device 230 normally communicates with the server 210 and the second central device 235 cannot normally communicate with the server 210.

First, in operation S410, the server 210 may transmit, to the first central device 230, a command (a lighting device brightness adjustment command) for adjusting the brightness of lights irradiated from the lighting devices 240.

When the first central device 230 receives the lighting device brightness adjustment command which is transmitted from the server 210 in operation S410, the first central device 230 may control the constant current regulator 220 according to the received lighting device brightness adjustment command in operation S420.

At this time, the first central device 230 may control the constant current regulator 220 in order for the constant current regulator 220 to output a specific current value among a plurality of predetermined current values.

Moreover, the first central device 230 may control the constant current regulator 220 and then may transmit its operating state to the server 210.

Subsequently, in operation S430, the constant current regulator 220 may supply a certain current to the lighting devices 240 through the power line in response to control by the first central device 230.

After the first central device 230 controls the constant current regulator 220 in operation S420, the first central device 230 may transfer the received lighting device brightness adjustment command to the second central device 235 in operation S440.

In this case, operation S430 and operation S440 may be simultaneously performed, or may be sequentially performed. The sequence in which operation S430 and operation S440 are performed may be changed based on a setting.

When the second central device 235 receives the lighting device brightness adjustment command which is transmitted from the first central device 230 in operation S440, the second central device 235 may control the constant current regulator 220 according to the received lighting device brightness adjustment command, and thus, control by the first central device 230 may be maintained as-is in operation S450.

In this case, in operation S450, since the second central device 235 performs the same control to the constant current regulator 220 as the first central device 230 controls the constant current regulator 220, the control of the constant current regulator 220 by the first central device 230 may be maintained as-is.

Therefore, since the first and second central devices 230 and 235 control the constant current regulator 220 according to the same lighting device brightness adjustment command, the constant current regulator 220 is stably controlled.

After the second central device 235 controls the constant current regulator 220 in operation S450, the second central device 230 may transmit its operating state to the first central device 230, and the first central device 230 may transfer the operating state of the second central device 230 to the server 210 in operation S460.

When the first central device 230 does not receive the operating state of the second central device 235, the first central device 230 may transmit a defective condition of the second central device 235 to the server 210.

Subsequently, in operation S470, the server 210 may monitor the first and second central devices 230 and 235, based on operating states of the first and second central devices 230 and 235.

In this case, when the server 210 does not receive the operating states of the first and second central devices 230 and 235, the server 210 may issue a warning that an error occurs in the central device of which operating state is not received.

According to the embodiment of the present invention, even when one of the two central devices 230 and 235 that control the constant current regulator 220 cannot normally communicate with the server 210, the other central device may transfer a command of the server 210 to the one central device. Accordingly, the constant current regulator 220 is stably controlled, and a stable operation of each of the lighting devices 240 is ensured.

The configuration and operation of the airfield lights control and monitoring system according to the embodiment of the present invention have been described according to embodiments, but the scope of the present invention is not limited to a specific embodiment. The airfield lights control and monitoring system according to the embodiment of the present invention may be variously replaced, corrected, and modified within the scope obvious to those skilled in the art.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is (US):

1. An airfield lights control and monitoring system for supplying a constant current to a plurality of lighting devices, the airfield lights control and monitoring system comprising:
a server configured to transmit a lighting device control command for controlling the plurality of lighting devices;
a constant current regulator configured to supply a predetermined current to the plurality of lighting devices according to external control; and
first and second central devices configured to receive the lighting device control command to control the constant current regulator according to the received lighting device control command,
wherein the first and second central devices transfer the lighting device control command therebetween.

2. The airfield lights control and monitoring system of claim 1, wherein when one of the first and second central devices cannot normally communicate with the server, one central device that normally communicates with the server controls the constant current regulator according to the lighting device control command and transfers the lighting device control command to the other central device that cannot normally communicate with the server.

3. The airfield lights control and monitoring system of claim 2, wherein the one central device controls the constant current regulator and transmits an operating state thereof to the server.

4. The airfield lights control and monitoring system of claim 2, wherein the other central device receives the lighting device control command from the one central device and controls the constant current regulator according to the received lighting device control command.

5. The airfield lights control and monitoring system of claim 4, wherein the other central device controls the constant current regulator and transmits an operating state thereof to the one central device, and the one central device transfers the received operating state of the other central device to the server.

6. The airfield lights control and monitoring system of claim 1, wherein the server checks a connection state between the first central device and the second central device and transmits the lighting device control command to a central device, which is determined as normally performing communication, among the first and second central devices.

7. The airfield lights control and monitoring system of claim 2, wherein the one central device transfers the lighting device control command to the other central device, and when the one central device does not receive an operating state from the other central device, the one central device transmits a defective condition of the other central device to the server.

8. The airfield lights control and monitoring system of claim 1, wherein the server transmits the lighting device control command to the first and second central devices and determines whether the first and second central devices normally operate, based on whether a reception check response is received from the first and second central devices.
